(19) United States
(12) Patent Application Publication
(10) Pub. No.: US 2026/0005748 A1
(43) Pub. Date: Jan. 1, 2026

(54) METHOD AND APPARATUS FOR BEAM HOPPING SCHEDULING IN COMMUNICATION SYSTEM

(71) Applicant: ELECTRONICS AND TELECOMMUNICATIONS RESEARCH INSTITUTE, Daejeon (KR)

(72) Inventor: Tae Chul HONG, Daejeon (KR)

(21) Appl. No.: 19/244,351

(22) Filed: Jun. 20, 2025

(30) Foreign Application Priority Data
Jun. 28, 2024 (KR) 10-2024-0085761

(51) Int. Cl. H04B 7/06; H04L 5/00; H04W 28/02

(52) U.S. Cl. CPC H04B 7/06952; H04L 5/0012; H04W 28/0278

(57) ABSTRACT

A method of a base station may comprise: configuring an allocation time, a hopping pattern period, and a beam hopping scheduling interval; generating a hopping pattern by allocating beams to N×M hopping slots according to scheduling information collected from a plurality of terminals based on a number M of simultaneously transmittable beams, a number N of hopping rounds within the hopping pattern period, a basic allocation power, and the allocation time; and transmitting information on the hopping pattern to a terminal, wherein the hopping pattern period is an integer multiple of the allocation time, the beam hopping scheduling interval is an integer multiple of the hopping pattern period, and M and N are positive integers.

### CROSS-REFERENCE TO RELATED APPLICATIONS

This application claims priority to Korean Patent Application No. 10-2024-0085761, filed on Jun. 28, 2024, with the Korean Intellectual Property Office (KIPO), the entire contents of which are hereby incorporated by reference.

### BACKGROUND

### 1. Technical Field

The present disclosure relates to a beam hopping scheduling technique in a communication system, and more particularly, to a beam hopping scheduling technique which facilitates dynamic scheduling of beam hopping when utilizing the beam hopping in a communication system.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication network may be a terrestrial network because it can provide communication services to terrestrial terminals located on the ground. Recently, there is an increasing demand for communication services not only for terrestrial terminals but also for non-terrestrial terminals such as unmanned aerial vehicles and satellites. To address this, techniques for a non-terrestrial network (NTN) are being discussed in 3GPP. In a non-terrestrial network, a satellite may use a multi-beam hopping technique when providing services across multiple regions. The satellite can maximize the capacity of satellite communication by using the multi-beam hopping technique, can improve utilization efficiency of frequency spectrum, and can effectively provide services to various regions. For this purpose, techniques for dynamically scheduling multi-beam hopping may be required to fully utilize the advantages of the multi-beam hopping technique.

### SUMMARY

The present disclosure for resolving the above-described problems is directed to providing a beam hopping scheduling method and apparatus which facilitate dynamic scheduling of beam hopping when utilizing the beam hopping in a communication system.

According to a first exemplary embodiment of the present disclosure, a method of a base station may comprise: configuring an allocation time, a hopping pattern period, and a beam hopping scheduling interval; generating a hopping pattern by allocating beams to NxM hopping slots according to scheduling information collected from a plurality of terminals based on a number M of simultaneously transmittable beams, a number N of hopping rounds within the hopping pattern period, a basic allocation power, and the allocation time; and transmitting information on the hopping pattern to a terminal, wherein the hopping pattern period is an integer multiple of the allocation time, the beam hopping scheduling interval is an integer multiple of the hopping pattern period, and M and N are positive integers.

The base station may allocate each of the beams to at least one hopping slot within the hopping pattern period.

The method may further comprise: configuring a maximum hopping period having a value greater than or equal to the hopping pattern period, wherein the base station transmits information on the maximum hopping period to the terminal by including the information on the maximum hopping period in the information on the hopping pattern.

The information on the hopping pattern may include at least one of: the allocation time, the hopping pattern period, the hopping pattern for the terminal, or a current position or a current hopping round in the hopping pattern for the terminal.

The method may further comprise: determining whether an inactive beam exists based on whether each of the beams allocated to the hopping slots is used for communication for a certain period of time; and in response to determining that an inactive beam exists, reducing a number of slots allocated to the inactive beam.

The method may further comprise: in response to the number of slots allocated to the inactive beam being a minimum number of allocated slots, reducing a power allocated to the inactive beam.

The method may further comprise: receiving reports on buffer statuses from the plurality of terminals; determining whether the hopping pattern is required to be changed for uplink based on the reports on the buffer statuses; in response to determining that the hopping pattern is required to be changed for uplink, changing the hopping pattern; and transmitting information on the changed hopping pattern to the terminal.

In the determining of whether the hopping pattern is required to be changed for uplink based on the reports on the buffer statuses, the base station may determine whether the hopping pattern is required to be changed based on whether an hourly increase in an uplink transmission waiting amount in at least one terminal is greater than a predetermined threshold.

The method may further comprise: identifying statuses of downlink buffers for the terminals; determining whether the hopping pattern is required to be changed for downlink based on the statuses of the downlink buffers; in response to determining that the hopping pattern is required to be changed for downlink, changing the hopping pattern; and transmitting information on the changed hopping pattern to the terminal.

In the determining of whether the hopping pattern is required to be changed for downlink based on the statuses of the downlink buffers, the base station may determine whether the hopping pattern is required to be changed for downlink based on whether an hourly increase in a downlink transmission waiting amount for at least one terminal is greater than a predetermined threshold.

According to a second exemplary embodiment of the present disclosure, a method of a terminal may comprise: attempting a communication connection with a base station within a maximum hopping period; in response to the communication connection with the base station being successful, receiving information on a hopping pattern from the base station; configuring communication parameters based on the receive information on the hopping pattern; and performing communication with the base station according to the configured communication parameters.

The method may further comprise: in response to a failure of the communication connection with the base station within the maximum hopping period, operating a sleep timer; and maintaining a sleep state while the sleep timer operates.

The information on the hopping pattern may include at least one of: an allocation time, a hopping pattern period, the hopping pattern for the terminal, or a current position or a current hopping round in the hopping pattern for the terminal.

The method may further comprise: transmitting a report on a buffer status to the base station; receiving, from the base station, information on a changed hopping pattern based on the report on the buffer status; changing the communication parameters based on the information on the changed hopping pattern; and performing communication with the base station according to the changed communication parameters.

According to a third exemplary embodiment of the present disclosure, a terminal comprising: at least one processor, wherein the at least one processor may cause the terminal to perform: attempting a communication connection with a base station within a maximum hopping period; in response to the communication connection with the base station being successful, receiving information on a hopping pattern from the base station; configuring communication parameters based on the receive information on the hopping pattern; and performing communication with the base station according to the configured communication parameters.

The at least one processor may further cause the terminal to perform: in response to a failure of the communication connection with the base station within the maximum hopping period, operating a sleep timer; and maintaining a sleep state while the sleep timer operates.

The information on the hopping pattern may include at least one of: an allocation time, a hopping pattern period, the hopping pattern for the terminal, or a current position or a current hopping round in the hopping pattern for the terminal.

The at least one processor may further cause the terminal to perform: transmitting a report on a buffer status to the base station; receiving, from the base station, information on a changed hopping pattern based on the report on the buffer status; changing the communication parameters based on the information on the changed hopping pattern; and performing communication with the base station according to the changed communication parameters.

According to the present disclosure, a satellite can dynamically schedule beam hopping to maximize the capacity of satellite communication. In addition, according to the present disclosure, the satellite can dynamically schedule beam hopping to increase the utilization of frequency spectrum. Furthermore, according to the present disclosure, the satellite can dynamically schedule beam hopping to effectively provide services to various regions.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram of a dynamic beam hopping scheduling method in a communication system.

FIG. 5 is a conceptual diagram illustrating a first exemplary embodiment of a method for changing a slot structure.

FIG. 6 is a flowchart illustrating a first exemplary embodiment of a beam hopping scheduling method in a communication system.

FIG. 7 is a flowchart illustrating a first exemplary embodiment of an operation method of a terminal according to a hopping pattern.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

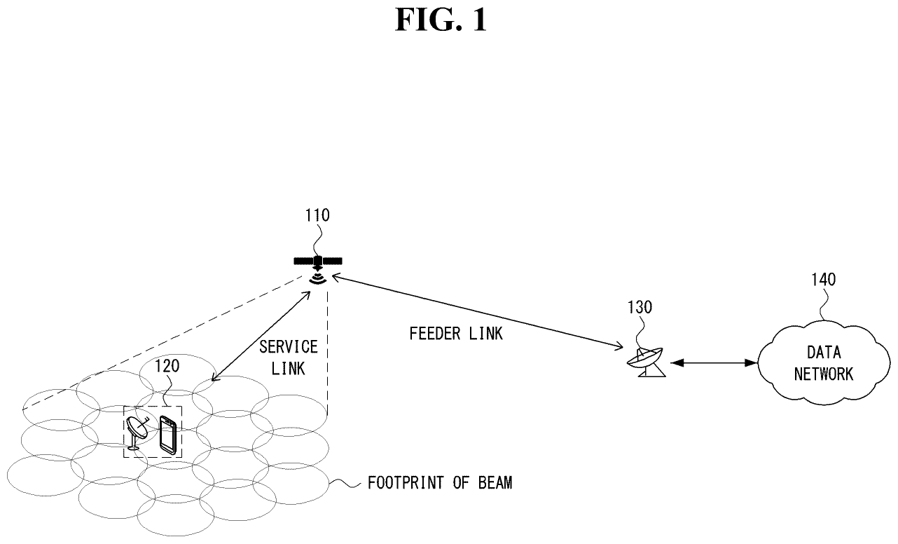

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

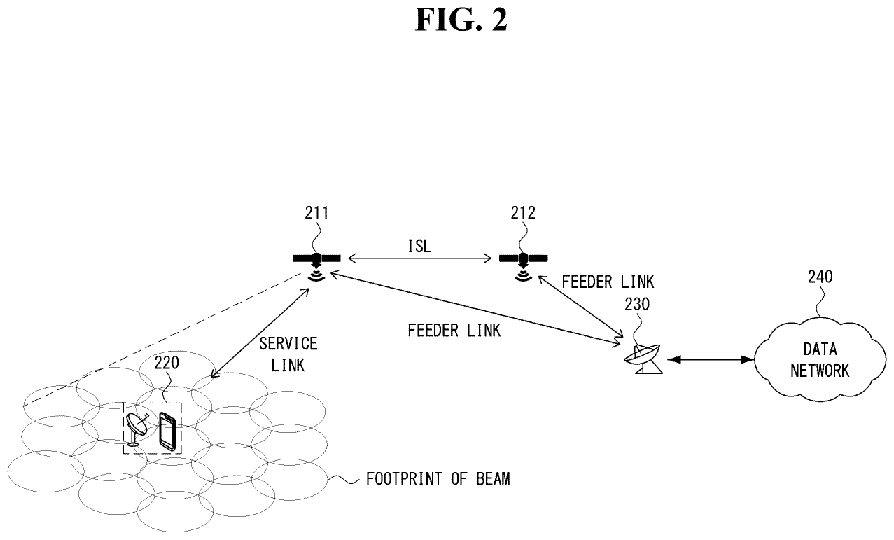

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

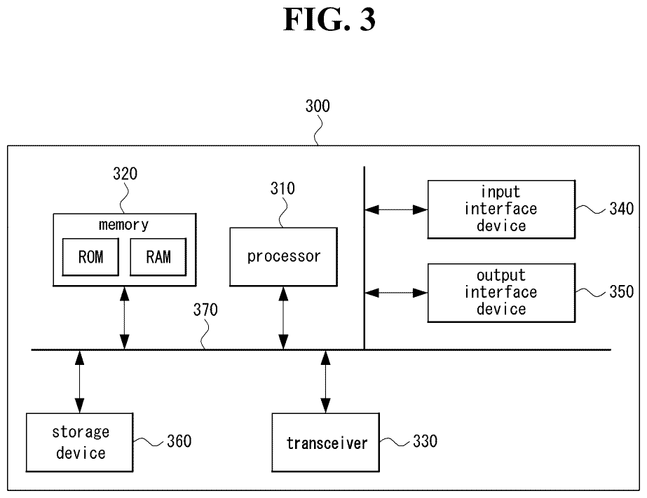

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel bandwidth | 30 MHz for band <6 GHz | |
| capability (service link) | 1 GHz for band >6 GHz | |
| Maximum distance between | 40,581 km | 1,932 km (altitude of 600 km) |
| satellite and communication | | 3,131 km (altitude of 1,200 km) |
| node (e.g. UE) at the minimum | | |
| elevation angle | | |
| Maximum round trip delay (RTD) | Scenario A: 541.46 ms | Scenario C: (transparent |
| (only propagation delay) | (service and feeder links) | payload: service and feeder links) |
| | Scenario B: 270.73 ms | 5.77 ms (altitude of 60 0 km) |
| | (only service link) | 41.77 ms (altitude of 1,200 km) |
| | | Scenario D: (regenerative |
| | | payload: only service link) |
| | | 12.89 ms (altitude of 600 km) |
| | | 20.89 ms (altitude of 1,200 km) |
| Maximum delay variation | 16 ms | 4.44 ms (altitude of 600 km) |
| within a single beam | | 6.44 ms (altitude of 1,200 km) |
| Maximum differential | 10.3 ms | 3.12 ms (altitude of 600 km) |
| delay within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

Meanwhile, a satellite may use a multi-beam hopping technique when providing services across multiple regions. The satellite may generate multiple beams in order to provide services to various regions on the ground by using the multi-beam hopping technique. In addition, the satellite may hop the beams to different regions over time by using the multi-beam hopping technique, thereby enabling efficient use of frequency resources and optimizing service coverages. Such a multi-beam hopping technique may have the following characteristics.
Beam generation: the satellite may generate multiple directional beams by using an antenna array. The satellite may provide communication services by targeting each beam to a specific region on the ground.
Time division multiple access (TDMA): the satellite may employ a TDMA scheme to enable the respective beams to provide services to regions corresponding to specific time slots.
Beam hopping: the satellite may move beams to different regions according to a specific pattern or schedule.
Service optimization: the satellite may optimize a specific pattern according to traffic demand and service requirements for each region.
Communication with a terminal: a terminal may be aware of the beam hopping schedule of the satellite. Accordingly, the terminal may perform communication when the beam hops to the region of the terminal.

The satellite can maximize the capacity of satellite communication by using the multi-beam hopping technique, can improve the utilization efficiency of frequency spectrum, and can effectively provide services to various regions. Therefore, the 3GPP is discussing the application of beam hopping techniques to a non-terrestrial network (NTN) system.

Techniques for dynamically scheduling beam hopping may be required to fully utilize the advantages of the multi-beam hopping techniques.

The present disclosure provides methods for dynamically scheduling beam hopping to enhance communication capacity and energy utilization efficiency when utilizing beam hopping in a communication system. The present disclosure may be generally applicable to a communication system performing beam hopping while using multiple beams without being limited to satellite communication.

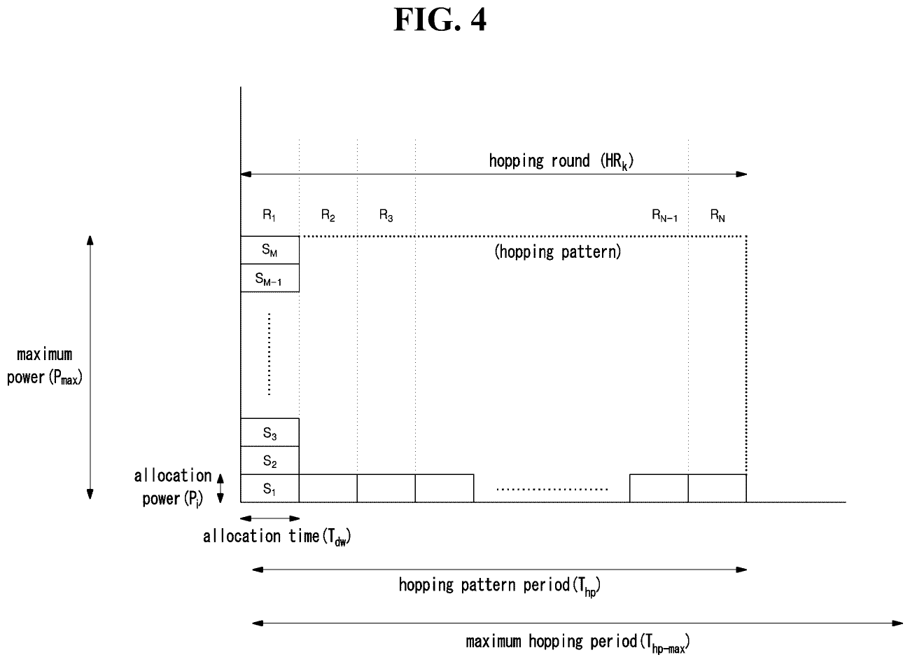

FIG. 4 is a conceptual diagram of a dynamic beam hopping scheduling method in a communication system.

Referring to FIG. 4, an allocation time T_{dw} may be a minimum time unit allocated to a beam. Here, T_{dw} may be a positive real number. The base station may simultaneously provide M beams during the allocation time T_{dw}. Here, M may be a positive integer. The beams may be distinguished by beam identifiers (i.e. beam IDs). The base station may allocate the beams to slots Si by mapping the beam identifiers (i.e. beam IDs) to the slots. Here, i may be a positive integer. The number of beams that can be simultaneously provided by the satellite may be limited by a maximum available transmission power value Pₘₐₓ of the satellite. Pₘₐₓ is a positive real number. A power allocated to a slot Si may be defined as Pᵢ. Accordingly, a relationship between the power Pᵢ allocated to the slot Si and the maximum power Pₘₐₓ may be expressed as in Equation 1.

$${P}_{max} \geq {\sum }_{i = 1}^{M} {P}_{i} \qquad [ Equation 1 ]$$

A basic allocation power Pᵤ may be defined as in Equation 2 and may be a positive real number. The satellite may adjust an allocation power based on the basic allocation power when determining the power to be allocated to the slot.

$${P}_{u} = \frac{{P}_{max}}{M} \qquad [ Equation 2 ]$$

The base station may allocate beams to slots in units of the allocation time. The base station may define the allocation time for allocating beams to slots as a round R. The base station may define N rounds as one hopping pattern period Tₕₚ. Here, N may be a positive integer, and Tₕₚ may be a positive real number. A round Rx may include M slots as in Equation 3. Here, k may be a positive integer less than or equal to N. Here, N may be a positive integer.

$${R}_{k} = \{ {S}_{1} , {S}_{2} , {S}_{3} , … , {S}_{M - 1} , {S}_{M} \} \qquad [ Equation 3 ]$$

The hopping pattern period may be expressed as in Equation 4.

$${T}_{hp} = {T}_{dw} \times N \qquad [ Equation 4 ]$$

The hopping pattern may be a pattern in which beam IDs are mapped to all slots within the hopping pattern period, in other words, N×M slots. Information on the hopping pattern may be shared between the base station (e.g. in a case where the satellite serves as the base station) and the terminal. The hopping pattern period may be a time to perform one instance of the configured hopping pattern. The hopping pattern may be dynamically changed. In such a case, scheduling may be changed in units of the hopping pattern period. In other words, in a system dynamically scheduling the hopping pattern, scheduling may be performed in time units that are integer multiples of the hopping pattern period. Assuming that L is an arbitrary positive integer, a time interval Tₕₚ₋ₛₕ for scheduling the hopping pattern may be as shown in Equation 5. Here, Thp-sh may be a positive real number.

$${T}_{hp - sh} = {T}_{hp} \times L \qquad [ Equation 5 ]$$

The base station may define a hopping round HR corresponding to a time of the hopping pattern period to distinguish repetitions of the hopping pattern period. The hopping round HR may include N rounds R₁ to R_{N} within the hopping pattern period, as shown in Equation 6.

$$H {R}_{k} = \{ {R}_{1} , {R}_{2} , {R}_{3} , … , {R}_{N - 1} , {R}_{N} \} \qquad [ Equation 6 ]$$

The hopping round HRₖ may be used to distinguish a duration within Tₕₚ₋ₛₕ. Here, k may be a positive integer having a value from 1 to L. A maximum hopping period Tₕₚ₋ₘₐₓ may be configured to be equal to or greater than a maximum period for synchronization signal block (SSB) transmission for cell search and synchronization in a physical layer. Here, Tₕₚ₋ₘₐₓ is a positive real number. The maximum hopping period may be the maximum waiting time for a terminal that is newly starting communication to establish a communication connection. Therefore, if the maximum hopping period is smaller than the maximum period for SSB transmission for cell search and synchronization in the physical layer, the maximum waiting time is always determined by a physical layer parameter regardless of Tₕₚ₋ₘₐₓ. The hopping pattern period Tₕₚ may be set to a value less than or equal to Tₕₚ₋ₘₐₓ.

When utilizing the hopping pattern designed based on the structure shown in FIG. 4, the base station may provide information on the designed hopping pattern to the terminal. The information on the hopping pattern transmitted from the base station to the terminal may be configured as shown in Equation 7.

$$[ {T}_{dv} , {T}_{hp} , hopping pattern , current position within hopping pattern , {T}_{hp - sh} , value of current H {R}_{k} ] \qquad [ Equation 7 ]$$

The hopping pattern of Equation 7 provided by the base station to the terminal may be a pattern of slots allocated to the terminal during N T_{dw} durations. For example, the hopping pattern of Equation 7 may be in the form of a bitmap consisting of N bits. In the hopping pattern of Equation 7, a value of ‘1’ may indicate a slot allocated to the terminal, and a value of ‘O’ may indicate a slot not allocated to the terminal. Since the base station can simultaneously utilize M beams, the bitmap may be recognized as a two-dimensional array. However, since the terminal is only concerned with whether a beam is allocated to the slot, the allocated slots may be recognized by the terminal through such a bitmap format.

When one or more slots are allocated in the hopping pattern, information on the current position may indicate which part of the hopping pattern corresponds to a moment when the current signaling information is being received. Information on k of the current HRₖ may indicate the moment when the current signaling information is being received. The terminal receiving such information may perform related operations according to the hopping pattern and scheduling period.

The base station may provide information on the hopping pattern shown in Equation 7 to the terminal when the terminal initially accesses the base station. Accordingly, the terminal may receive the information on the hopping pattern from the base station when initially accessing the base station. The hopping pattern may be changed. In such a case, the base station may additionally provide information on the changed hopping pattern to the terminal. Accordingly, the terminal may additionally receive the information on the changed hopping pattern from the base station. Even when the hopping pattern is changed, there may be no information that needs to be updated by the terminal. In such a case, the base station may not provide the terminal with the information on the changed hopping pattern. In addition, the base station may provide the terminal with update information regarding transmission parameters such as a sleeping cycle (e.g. 3GPP discontinuous reception (DRX) parameters) for power saving according to the change in the hopping pattern.

FIG. 4 also illustrates information on allocation powers. However, the base station may not include information on allocation powers in the information on the hopping pattern provided to the terminal. The information on the allocation powers used for downlink may not necessarily be required by the terminal for beam hopping operations. The base station may provide the information on the allocation powers to the terminal when the terminal requires the information on the allocation powers. The information on the maximum hopping period may be a parameter that should be utilized even at initial access. Accordingly, the base station may provide the information on the maximum hopping period to the terminal as a system parameter value. The base station may use, for example, 9 beams B1 to B9. In this case, the number M of beams that can be simultaneously formed by the base station may be, for example, 3. The number N of rounds in the hopping pattern may be, for example, 3. In such a case, the hopping pattern within one hopping round may be configured as shown in Table 4.

TABLE 4
HR₁

| R₁ | R₂ | R₃ |
|---|---|---|
| B1 | B4 | B7 |
| B2 | B5 | B8 |
| B3 | B6 | B9 |

When T_{dw} is equal to Tᵤ, and L is 2, the information on the hopping pattern provided to a terminal located in B1 at HR₁-R₁ may be as shown in Equation 8.

$$Hopping pattern information = [ {T}_{u} , 3 {T}_{u} , {100}_{2} , 1 , 6 {T}_{u} , 1 ] \qquad [ Equation 8 ]$$

When M is 3 and N is 6, the hopping pattern within one hopping round may be configured as shown in Table 5. In such a configuration, the base station may maintain Tₕₚ to be the same as in the case where M is 3 and N is 3, by setting T_{dw} to one-half of T_{dw} for the case where M is 3 and N is 3. When the base station sets T_{dw} to one-half of T_{dw} for the case where M is 3 and N is 3 and arranges two round patterns consecutively, the base station may configure the hopping pattern within one hopping round in the same manner as in the case where M is 3 and N is 3. Here, each round pattern may be a pattern indicating beams allocated to slots of each round within the hopping round.

TABLE 5
HR₁

| R₁ | R₂ | R₃ | R₄ | R₅ | R₆ |
|---|---|---|---|---|---|
| B1 | B4 | B7 | B1 | B4 | B7 |
| B2 | B5 | B8 | B2 | B5 | B8 |
| B3 | B6 | B9 | B3 | B6 | B9 |

When T_{dw} is equal to Tᵤ, and L is 2, the information on the hopping pattern provided to the terminal located in B1 at HR₁-R₁ according to Table 5 may be as shown in Equation 9.

$$Hopping pattern information = [ {T}_{u} , 6 {T}_{u} , {100100}_{2} , 1 , 12 {T}_{u} , 1 ] \qquad [ Equation 9 ]$$

The method of changing the hopping pattern may include a method of changing the slots and a method of changing allocation of the beam IDs mapped to the slots.

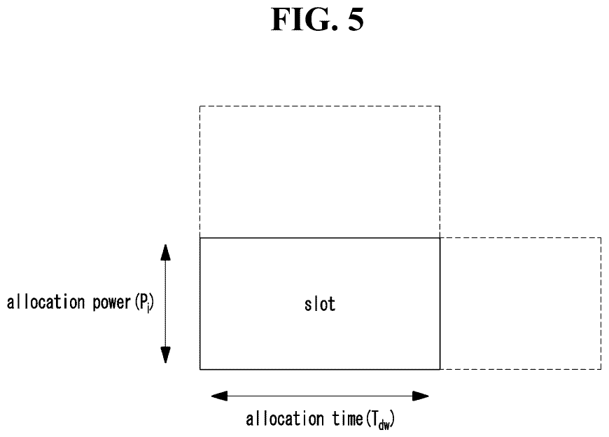

FIG. 5 is a conceptual diagram illustrating a first exemplary embodiment of a method for changing a slot structure.

Referring to FIG. 5, a slot structure may be changed by changing a size of the allocation power. Alternatively, the slot structure may be changed by changing a size of the allocation time. The hopping pattern may be changed by changing the slot structure in this manner.

In the method of changing the size of the allocation time, the base station may allocate different allocation times to respective terminals. In such a case, configuration values to be managed by the base station may increase excessively. Therefore, rather than changing the allocation time itself, the base station may define a basic unit allocation time and may allocate multiple slots as needed. The base station may configure the hopping pattern information by configuring different allocation time units for respective terminals. Accordingly, the terminal may utilize such a method of configuring different allocation time units for the respective terminals.

The base station may use a method of changing the beam IDs mapped to the slots. In this case, the base station may allocate each beam ID to at least one slot during Tₕₚ. Accordingly, the number of beam IDs and the number of slots N×M may satisfy Equation 10.

$$N \times M > number of beam IDs \qquad [ Equation 10 ]$$

In other words, for dynamic scheduling to be possible and to obtain advantages therefrom, the number of slots should be greater than the number of beam IDs. In a case where the number of beam IDs is greater than the number of slots, the hopping patterns within two hopping rounds may be configured as shown in Table 6.

[Equation 6]

| | |
|---|---|
| HR₁ | HR₂ |

| | | | | | | | |
|---|---|---|---|---|---|---|---|
| R₁ | R₂ | R₃ | R₄ | R₁ | R₂ | R₃ | R₄ |

| | | | |
|---|---|---|---|
| B6 | B12 | B6 | B12 |
| B5 | B11 | B5 | B11 |
| B4 | B10 | B4 | B10 |
| B3 | B9 | B3 | B9 |
| B2 | B8 | B2 | B8 |
| B1 | B7 | B1 | B7 |

In Table 6, there may be 12 beams, and 24 slots may exist within a HR. In such a case, the base station may allocate two slots per beam to fairly allocate the beams to the slots. However, the base station may not allocate beam IDs to 12 slots while allocating each beam ID to at least one slot during Tₕₚ. In this manner, the base station may save power. In addition, the base station may additionally allocate slots to regions with high traffic or service demands.

Table 7 may illustrate the hopping patterns within hopping rounds when four slots are allocated to B1 to B4 under the same condition as in Table 6. B1 to B4 may have high traffic processing demands. Accordingly, the base station may allocate a large number of slots to B1 to B4. In contrast, B5 to B12 may not have high traffic demands. Accordingly, the base station may allocate one slot to each of B5 to B12.

TABLE 7

| | |
|---|---|
| HR₁ | HR₂ |

| R₁ | R₂ | R₃ | R₄ | R₁ | R₂ | R₃ | R₄ |
|---|---|---|---|---|---|---|---|
| B6 | B8 | B10 | B12 | B6 | B8 | B10 | B12 |
| B5 | B7 | B9 | B11 | B5 | B7 | B9 | B11 |
| B4 | B4 | B4 | B4 | B4 | B4 | B4 | B4 |
| B3 | B3 | B3 | B3 | B3 | B3 | B3 | B3 |
| B2 | B2 | B2 | B2 | B2 | B2 | B2 | B2 |
| B1 | B1 | B1 | B1 | B1 | B1 | B1 | B1 |

The base station may change the hopping pattern by changing the powers allocated to slots as shown in Table 8. In Table 8, terminals using B6, B8, and B10 may require a large amount of downlink traffic. Accordingly, the base station may increase the powers of B6, B8, and B10. In Table 8, a terminal using B1 may require a large amount of traffic for uplink as well as downlink. Accordingly, the base station may increase the power of B1. Additionally, the base station may allocate multiple slots to B1. Table 8 may represent a situation where the base station can simultaneously provide 6 beams. In Table 8, R₁ and R₄ may represent cases where the corresponding power is distributed across 5 and 4 slots, respectively. R₂ and R₃ in Table 8 may represent cases where, after subtracting a power equivalent to one basic slot, the remaining power is distributed across 3 slots.

TABLE 8

| | |
|---|---|
| HR₁ | HR₂ |

| R₁ | R₂ | R₃ | R₄ | R₁ | R₂ | R₃ | R₄ |
|---|---|---|---|---|---|---|---|
| B5 | | | B12 | B5 | | | B12 |
| B4 | B7 | B9 | B11 | B4 | B7 | B9 | B11 |
| B3 | B6 | B8 | B10 | B3 | B6 | B8 | B10 |
| B2 | | | | B2 | | | |
| B1 | B1 | B1 | B1 | B1 | B1 | B1 | B1 |

The base station may dynamically schedule the hopping pattern according to the situation as shown in Table 7 or Table 8 at each configured Tₕₚ₋ₛₕ. The base station may require information for hopping scheduling in order to schedule the hopping pattern. In a wireless communication system, a packet scheduler may mainly utilize information such as channel states, service types, and transmission data amounts as information for packet scheduling. The base station may utilize the information for packet scheduling as information for hopping scheduling in order to schedule the hopping patterns.

The base station may determine information related to a downlink traffic amount based on the amount of data in an internal buffer of the base station. The base station may determine information related to service types through service types allocated to each terminal or through quality of service (QOS) information. The base station may determine an uplink traffic amount through the amount of data waiting to be transmitted from terminals. Accordingly, the terminals may report the amount of data waiting to be transmitted to the base station. Then, the base station may receive information regarding the amount of data waiting to be transmitted from the terminals. In the case of 3GPP, the terminal may report a buffer status to the base station by using a message defined as a buffer status report (BSR). Therefore, the base station may collect information on the uplink traffic by utilizing the buffer status reports of the terminals.

The base station may collect channel state information from multiple terminals performing communication through beams. In a conventional wireless communication system, the base station may collect and utilize information related to the channel states by using various pilots (i.e. reference signals). Accordingly, the base station may collect and utilize information related to the channel states by using various pilots (i.e. reference signals) for beam hopping scheduling.

Information regarding inactive beams may be newly utilized in determining the hopping patterns, in addition to the information conventionally used in packet scheduling in the base station. Here, an inactive beam may be a beam for which no communication is performed during an allocated time. Here, the allocated time for the beam may be a predetermined time, for example, 10 minutes or 20 minutes. When a large number of slots are allocated to such an inactive beam, the base station may adjust the number of allocated slots in a manner that reduces the number of slots. When a single slot is allocated to the inactive beam, the base station may adjust the allocation by reducing the size of the allocated power.

In the method of reducing the number of slots, the base station may not immediately adjust the number of slots to the minimum allocation number. Here, the minimum allocation number may be, for example, one. The base station may gradually reduce the number of slots by reducing the number of slots previously allocated to the inactive beam by half.

The base station may collect the above-described information during Tₕₚ₋ₛₕ and may schedule the hopping patterns based on the collected information. Accordingly, the terminals may report information regarding the uplink traffic amount to the base station during the last hopping round of Tₕₚ₋ₛₕ. Accordingly, the base station may receive reports regarding the uplink traffic amount from the terminals during the last hopping round of Tₕₚ₋ₛₕ. The terminals may support the collection of information for hopping scheduling because the terminals can obtain information on when to report, in other words, which round is the last hopping round, based on the information on the hopping pattern received from the base station.

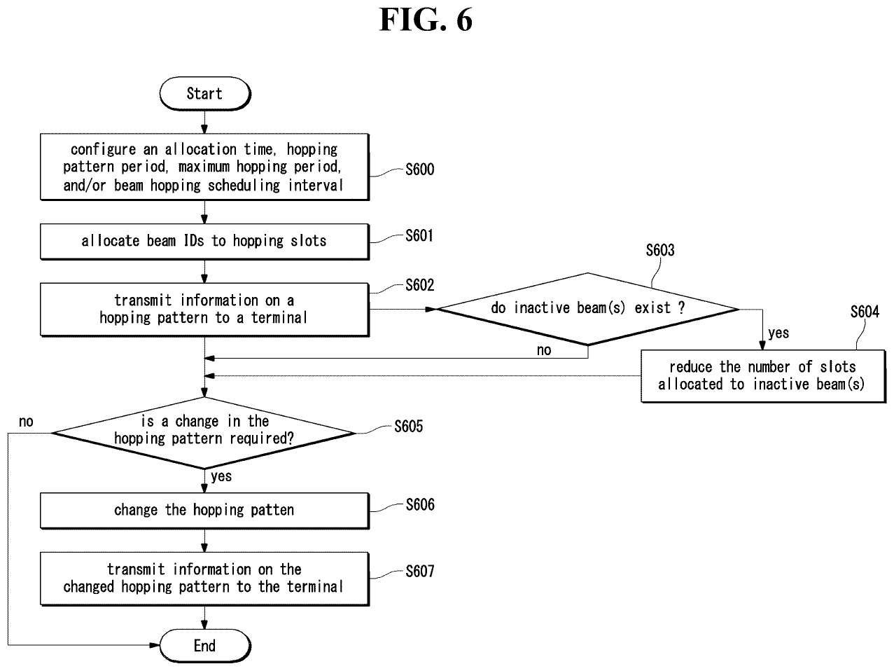

FIG. 6 is a flowchart illustrating a first exemplary embodiment of a beam hopping scheduling method in a communication system.

Referring to FIG. 6, the base station may configure an allocation time T_{dw}, may configure a hopping pattern period Tₕₚ as an integer multiple of the allocation time, may configure a maximum hopping period Tₕₚ₋ₘₐₓ that is equal to or greater than the hopping pattern period, and may configure a beam hopping scheduling interval Tₕₚ₋ₛₕ as an integer multiple of the hopping pattern period (S600). The base station may allocate beam IDs to N×M hopping slots based on the number M of beams that can be simultaneously transmitted, the number N of hopping rounds, a basic allocation power, and the allocation time (S601). In this case, the base station may allocate the beam IDs to the hopping slots according to hopping scheduling information (information utilized for scheduling) collected from the terminals. The base station may allocate each beam ID to at least one hopping slot. The base station may transmit information on the hopping pattern to the terminal (S602). Then, the terminal may receive the information on the hopping pattern from the base station.

Meanwhile, the base station may determine whether an inactive beam exists (S602). When an inactive beam exists as a result of the determination, the base station may reduce the number of slots allocated to the inactive beam (S603). In this case, when the number of slots allocated to the inactive beam is the minimum number of allocated slots, the base station may reduce the power for the inactive beam. The base station may determine whether an inactive beam exists based on whether the beams allocated to the hopping slots are used for communication for a certain period of time. The base station may determine whether a change in the hopping pattern is required based on the hopping scheduling information collected over a certain period of time (S604).

### Hopping Pattern Change Method 1

For example, the terminals may report buffer statuses to the base station. Accordingly, the base station may receive reports regarding the buffer statuses from the terminals. The base station may determine whether a change in the hopping pattern is required for uplink based on the received reports regarding the buffer statuses (S604). In this case, the base station may determine that a change in the hopping pattern is required for uplink when the allocated hopping slots are insufficient compared to the amount of uplink transmission waiting in at least one terminal. For example, the base station may determine that a change in the hopping pattern is required for uplink when an increase in the amount of uplink transmission waiting in at least one terminal for a certain period of time exceeds a predetermined threshold, based on the reports regarding the buffer statuses.

When it is determined that a change in the hopping pattern is required for uplink, the base station may change the hopping pattern. In this case, the base station may change the hopping pattern for uplink by adjusting the beam IDs allocated to the hopping slots. The base station may transmit the information on the changed hopping pattern to the terminal (S605). Then, the terminal may receive the information on the changed hopping pattern from the base station.

### Hopping Pattern Change Method 2

The base station may identify statuses of downlink buffers within the base station for the terminals. The base station may determine whether a change in the hopping pattern is required for downlink based on the identified statuses of the downlink buffers. In this case, the base station may determine that a change in the hopping pattern is required for downlink when the allocated hopping slots are insufficient compared to the amount of downlink transmission waiting for at least one terminal.

For example, the base station may determine that a change in the hopping pattern is required for downlink when an increase in the amount of downlink transmission for at least one terminal for a certain period of time exceeds a predetermined threshold, based on the identified statuses of the downlink buffers.

When it is determined that a change in the hopping pattern is required for downlink, the base station may change the hopping pattern. In this case, the base station may change the hopping pattern for downlink by adjusting the beam IDs allocated to the hopping slots. Alternatively, the base station may change the hopping pattern for downlink by adjusting the power of the beams. The base station may transmit information on the changed hopping pattern for downlink to the terminal (S605). Then, the terminal may receive the information on the changed hopping pattern for downlink from the base station.

### Hopping Pattern Change Method 3

For example, the terminals may report buffer statuses to the base station. Accordingly, the base station may receive reports regarding the buffer statuses from the terminals. The base station may determine whether a change in the hopping pattern is required for uplink based on the received reports regarding the buffer statuses. In this case, the base station may determine that a change in the hopping pattern is required for uplink when the allocated hopping slots are insufficient compared to the amount of uplink transmission waiting in at least one terminal. For example, the base station may determine that a change in the hopping pattern is required for uplink when an increase in the amount of uplink transmission waiting in at least one terminal for a certain period of time exceeds a predetermined threshold, based on the reports regarding the buffer statuses.

When it is determined that a change in the hopping pattern is required for uplink, the base station may determine whether a change in the hopping pattern is required for downlink. Alternatively, even when it is determined that a change in the hopping pattern is not required for uplink, the base station may determine whether a change in the hopping pattern is required for downlink.

The base station may identify the statuses of downlink buffers within the base station for the terminals. The base station may determine whether a change in the hopping pattern is required for downlink based on the identified statuses of the downlink buffers. In this case, the base station may determine that a change in the hopping pattern is required for downlink when the allocated hopping slots are insufficient compared to the amount of downlink transmission waiting for at least one terminal.

For example, the base station may determine that a change in the hopping pattern is required for downlink when an increase in the amount of downlink transmission waiting for at least one terminal over a certain period of time exceeds a predetermined threshold, based on the identified statuses of the downlink buffers. When it is determined that a change in the hopping pattern is required for downlink, the base station may change the hopping pattern. In this case, the base station may change the hopping pattern by adjusting the beam IDs allocated to the hopping slots. Alternatively, the base station may change the hopping pattern by adjusting the power of the beams.

The base station may determine that a change in the hopping pattern is not required for downlink. In this case, the base station may change the hopping pattern for uplink by adjusting the beam IDs allocated to the hopping slots. The base station may transmit information on the changed hopping pattern to the terminal (S605). Then, the terminal may receive the information on the changed hopping pattern from the base station. As described above, the base station may determine whether a change in the hopping pattern is required for downlink when a change in the hopping pattern is required for uplink. Alternatively, the base station may also determine whether a change in the hopping pattern is required for downlink even when it is determined that a change in the hopping pattern is not required for uplink.

### Hopping Pattern Change Method 4

The base station may identify statuses of downlink buffers within the base station for the terminals. The base station may determine whether a change in the hopping pattern is required for downlink based on the identified statuses of the downlink buffers. In this case, the base station may determine that a change in the hopping pattern is required for downlink when the allocated hopping slots are insufficient compared to the amount of downlink transmission waiting for at least one terminal.

For example, the base station may determine that a change in the hopping pattern is required for downlink when an increase in the amount of downlink transmission waiting for at least one terminal over a certain period of time exceeds a predetermined threshold, based on the identified statuses of the downlink buffers.

When it is determined that a change in the hopping pattern is required for downlink, the base station may determine whether a change in the hopping pattern is required for uplink. Alternatively, even when it is determined that a change in the hopping pattern is not required for downlink, the base station may determine whether a change in the hopping pattern is required for uplink.

For example, the terminals may report buffer statuses to the base station. Accordingly, the base station may receive reports regarding the buffer statuses from the terminals. The base station may determine whether a change in the hopping pattern is required for uplink based on the received reports regarding the buffer statuses. In this case, the base station may determine that a change in the hopping pattern is required for uplink when the allocated hopping slots are insufficient compared to the amount of uplink transmission waiting in at least one terminal. For example, the base station may determine that a change in the hopping pattern is required for uplink when an increase in the amount of uplink transmission waiting in at least one terminal over a certain period of time exceeds a predetermined threshold, based on the reports regarding the buffer statuses.

When it is determined that a change in the hopping pattern is required for uplink, the base station may change the hopping pattern. In this case, the base station may change the hopping pattern by adjusting the beam IDs allocated to the hopping slots. The base station may transmit information on the changed hopping pattern to the terminal (S605). Then, the terminals may receive the information on the changed hopping pattern from the base station.

When no adjustment of the hopping pattern is required for uplink and no adjustment of the hopping pattern is required for downlink, update information to be provided to the terminals may not exist.

When an inactive beam exists and no adjustment of the hopping pattern is required for uplink and no adjustment of the hopping pattern is required for downlink, the information related to the reduction in the number of slots allocated to the inactive beam may be updated and reflected only within the base station. The information related to the reduction in the number of slots allocated to the inactive beam may be information that should be received by the terminals allocated with the inactive beam, but no active terminals may exist for the inactive beam.

When no adjustment of the hopping pattern is required for uplink and an adjustment of the hopping pattern is required for downlink, the base station may perform scheduling by considering both the slot allocation pattern and the power allocation pattern. In addition, when an adjustment of the hopping pattern is required for uplink and an adjustment of the hopping pattern is required for downlink, the base station may perform scheduling by considering both the slot allocation pattern and the power allocation pattern.

Finally, when an adjustment of the hopping pattern is required for uplink and no adjustment of the hopping pattern is required for downlink, the base station may perform scheduling by considering only the slot allocation pattern without considering the power allocation pattern. In this case, the base station may perform scheduling only for the slot allocation pattern, and may use a method of reducing the power allocated to the downlink according to the number of additionally allocated slots in order to save power.

The base station may transmit information on the changed hopping pattern, which is determined according to the above-described process, to the terminal in a new hopping round, so that the terminal applies the changed hopping pattern. Therefore, when the terminal receives the information on the changed hopping pattern, the terminal may maintain the initially received slot positions without change. The terminal may change the initially received slot positions in the case of inactive beams. When newly allocated slots exist ahead of the initially received slot positions, the terminal may utilize the newly allocated slots from the next hopping round.

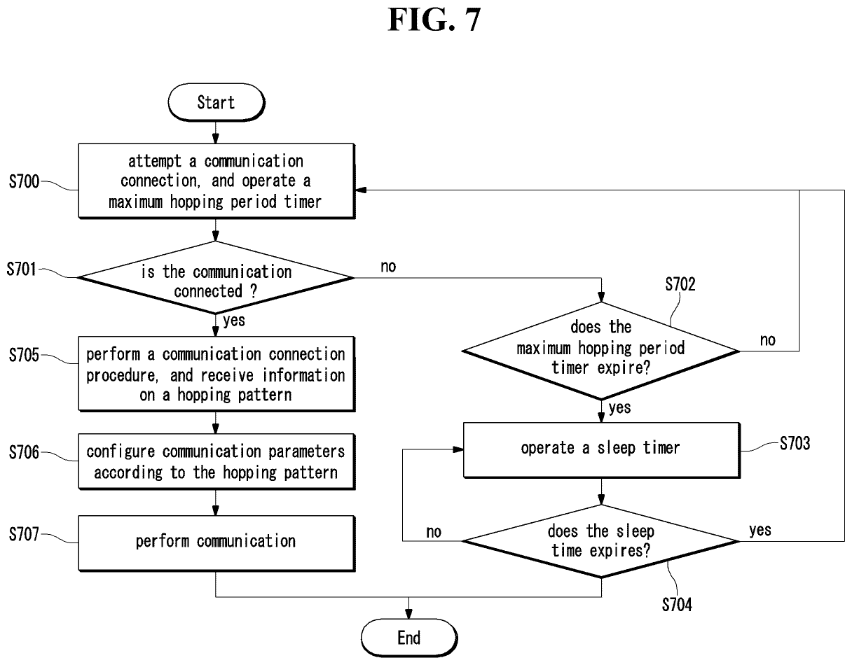

FIG. 7 is a flowchart illustrating a first exemplary embodiment of an operation method of a terminal according to a hopping pattern.

Referring to FIG. 7, the terminal may attempt to connect to the base station to start communication and may operate a maximum hopping period timer (S700). In the 3GPP, the terminal may connect to the base station through a process such as performing a random access procedure by receiving SSB(s). Therefore, the terminal may continuously attempt to receive SSB(s) in order to attempt connection with the base station.

The maximum hopping period may be longer than the maximum period of SSB transmission by the base station. In this case, the terminal may have prior knowledge of the maximum period of SSB transmission. Therefore, the terminal may continuously attempt connection during the maximum hopping period. The terminal may determine whether the communication connection is successful (S701). When it is determined that the communication connection is not successful, the terminal may determine whether the maximum hopping period timer has expired (S702). When the maximum hopping period timer has not expired, the terminal may perform step S700. In contrast, when the maximum hopping period timer has expired, the terminal may determine that the terminal is located in an area where communication is impossible and may operate a separate sleep timer (S703). In this situation, if the terminal continuously attempts communication, power may be wasted. Therefore, the terminal may perform a procedure of periodically attempting communication again while saving power through the sleep timer.

The terminal may determine whether the sleep timer has expired (S704). When it is determined that the sleep timer has not expired, the terminal may perform step S703. In contrast, when it is determined that the sleep timer has expired, the terminal may perform step S700.

Meanwhile, when the terminal determines that the communication connection is successful, the terminal may perform a communication connection procedure and may receive information on the hopping pattern from the base station (S705). The terminal may configure communication parameters according to the received hopping pattern (S706) and may perform communication with the base station (S707).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
configuring an allocation time, a hopping pattern period, and a beam hopping scheduling interval;
generating a hopping pattern by allocating beams to N×M hopping slots according to scheduling information collected from a plurality of terminals based on a number M of simultaneously transmittable beams, a number N of hopping rounds within the hopping pattern period, a basic allocation power, and the allocation time; and
transmitting information on the hopping pattern to a terminal,
wherein the hopping pattern period is an integer multiple of the allocation time, the beam hopping scheduling interval is an integer multiple of the hopping pattern period, and M and N are positive integers.

2. The method according to claim 1, wherein the base station allocates each of the beams to at least one hopping slot within the hopping pattern period.

3. The method according to claim 1, further comprising: configuring a maximum hopping period having a value greater than or equal to the hopping pattern period,
wherein the base station transmits information on the maximum hopping period to the terminal by including the information on the maximum hopping period in the information on the hopping pattern.

4. The method according to claim 1, wherein the information on the hopping pattern includes at least one of: the allocation time, the hopping pattern period, the hopping pattern for the terminal, or a current position or a current hopping round in the hopping pattern for the terminal.

5. The method according to claim 1, further comprising:
determining whether an inactive beam exists based on whether each of the beams allocated to the hopping slots is used for communication for a certain period of time; and
in response to determining that an inactive beam exists, reducing a number of slots allocated to the inactive beam.

6. The method according to claim 5, further comprising: in response to the number of slots allocated to the inactive beam being a minimum number of allocated slots, reducing a power allocated to the inactive beam.

7. The method according to claim 1, further comprising:
receiving reports on buffer statuses from the plurality of terminals;
determining whether the hopping pattern is required to be changed for uplink based on the reports on the buffer statuses;
in response to determining that the hopping pattern is required to be changed for uplink, changing the hopping pattern; and
transmitting information on the changed hopping pattern to the terminal.

8. The method according to claim 7, wherein in the determining of whether the hopping pattern is required to be changed for uplink based on the reports on the buffer statuses, the base station determines whether the hopping pattern is required to be changed based on whether an hourly increase in an uplink transmission waiting amount in at least one terminal is greater than a predetermined threshold.

9. The method according to claim 1, further comprising:
identifying statuses of downlink buffers for the terminals;
determining whether the hopping pattern is required to be changed for downlink based on the statuses of the downlink buffers;
in response to determining that the hopping pattern is required to be changed for downlink, changing the hopping pattern; and
transmitting information on the changed hopping pattern to the terminal.

10. The method according to claim 9, wherein in the determining of whether the hopping pattern is required to be changed for downlink based on the statuses of the downlink buffers, the base station determines whether the hopping pattern is required to be changed for downlink based on whether an hourly increase in a downlink transmission waiting amount for at least one terminal is greater than a predetermined threshold.

11. A method of a terminal, comprising:
attempting a communication connection with a base station within a maximum hopping period;
in response to the communication connection with the base station being successful, receiving information on a hopping pattern from the base station;
configuring communication parameters based on the receive information on the hopping pattern; and
performing communication with the base station according to the configured communication parameters.

12. The method according to claim 11, further comprising:
in response to a failure of the communication connection with the base station within the maximum hopping period, operating a sleep timer; and
maintaining a sleep state while the sleep timer operates.

13. The method according to claim 11, wherein the information on the hopping pattern includes at least one of: an allocation time, a hopping pattern period, the hopping pattern for the terminal, or a current position or a current hopping round in the hopping pattern for the terminal.

14. The method according to claim 11, further comprising:
transmitting a report on a buffer status to the base station;
receiving, from the base station, information on a changed hopping pattern based on the report on the buffer status;
changing the communication parameters based on the information on the changed hopping pattern; and
performing communication with the base station according to the changed communication parameters.

15. A terminal comprising: at least one processor, wherein the at least one processor causes the terminal to perform:
attempting a communication connection with a base station within a maximum hopping period;
in response to the communication connection with the base station being successful, receiving information on a hopping pattern from the base station;
configuring communication parameters based on the receive information on the hopping pattern; and
performing communication with the base station according to the configured communication parameters.

16. The terminal according to claim 15, wherein the at least one processor further causes the terminal to perform:
in response to a failure of the communication connection with the base station within the maximum hopping period, operating a sleep timer; and
maintaining a sleep state while the sleep timer operates.

17. The terminal according to claim 15, wherein the information on the hopping pattern includes at least one of: an allocation time, a hopping pattern period, the hopping pattern for the terminal, or a current position or a current hopping round in the hopping pattern for the terminal.

18. The terminal according to claim 15, wherein the at least one processor further causes the terminal to perform:
transmitting a report on a buffer status to the base station;
receiving, from the base station, information on a changed hopping pattern based on the report on the buffer status;
changing the communication parameters based on the information on the changed hopping pattern; and
performing communication with the base station according to the changed communication parameters.
